(19) United States
(12) Patent Application Publication
(10) Pub. No.: US 2019/0214611 A1
(43) Pub. Date: Jul. 11, 2019

(54) LAMINATE MATERIAL

(71) Applicant: SHOWA DENKO PACKAGING CO., LTD., Kanagawa (JP)

(72) Inventors: Kensuke NAGATA, Kanagawa (JP); Tsutomu GANSE, Kanagawa (JP)

(73) Assignee: SHOWA DENKO PACKAGING CO., LTD., Kanagawa (JP)

(21) Appl. No.: 16/307,592

(22) PCT Filed: May 30, 2017
(86) PCT No.: PCT/JP2017/020107

§ 371 Date: Dec. 6, 2018

(30) Foreign Application Priority Data
Jun. 6, 2016 (JP) 2016-112420

(51) Int. Cl. H01M 2/02; H01G 9/04; H01G 9/08; H01G 9/022; H01G 9/02

(52) U.S. Cl. CPC H01M 2/0287; H01M 2/028; H01M 2/0285; H01M 2002/0297; H01G 9/08; H01G 9/022; H01G 9/02; H01G 9/04

(57) ABSTRACT

Provided is a laminate material capable of easily forming a metal exposed portion. The laminate material 1 is a laminate material formed by bonding and laminating a resin layer 17, 18 on at least one surface of a metal foil 11. A recess 27, 28 in which a foil thickness of the metal foil 11 is reduced is formed on a part of a bonding surface of the metal foil. A peeled portion 21, 22 where the resin layer 17, 18 corresponding to the recess 27, 28 has been peeled from the metal foil 11 is formed.

### FIELD OF THE INVENTION

The present invention relates to a laminate material used for a packaging body for a power storage device or a packaging material for food and pharmaceutical products.

### TECHNICAL BACKGROUND

In accordance with downsizing and weight reduction of a battery, such as, e.g., a battery for mobile communication terminal equipment, a battery for automobiles, a battery for regenerative energy recovery, a capacitor, and an all-solid state battery, in place of a conventionally used packaging body made of metal, a packaging body made of a laminate material in which resin films are bonded to both surfaces of a metal foil is increasingly used (see Patent Document 1).

In the laminate case for a capacitor as described in Patent Document 1, an electrode connection portion is formed by cutting out the resin film layer on the inner side of the laminate case to expose the metal foil, and an electrode terminal is formed by cutting out the resin film layer on the outer side of the laminate case to expose the metal foil. Since this type of laminate case requires no tab lead, downsizing and weight reduction of the capacitor can be attained.

Further, as a method of exposing a metal foil of a laminate material, the present applicant proposed a method. In the method, in a step of bonding a metal foil and a resin film, an adhesive agent unapplied portion is formed at an exposure target portion, and the resin film corresponding to the adhesive agent unapplied portion is cut out after the bonding step (see Patent Document 2). According to this method, since the metal foil and the resin film are not bonded at the exposure target portion, the resin film can be easily cut out and the metal foil surface will not be contaminated.

Furthermore, there is also a method in which in a step of bonding a metal foil and a resin film, a peelable sheet is bonded to the exposure target portion of the metal foil and then the resin film is bonded thereon, thereafter at the time of removing the resin film, the peelable sheet is removed with the peelable sheet bonded to the resin film.

### PRIOR ART DOCUMENTS

### Patent Documents

Patent Document 1: Japanese Unexamined Patent Application Publication No. 2013-161674
Patent Document 2: Japanese Unexamined Patent Application Publication No. 2015-205504

### SUMMARY OF THE INVENTION

### Problems to be Solved by the Invention

In the method described in Patent Document 2, the size and forming position of the metal exposed portion need to be determined at the step of bonding the metal foil and the resin film and therefore cannot be changed after bonding. Therefore, when the shape or position of the metal exposed portion differs, a dedicated laminate material must be prepared for it. Further, a dedicated adhesive agent application roll is needed according to the shape, number, and position of the metal exposed portion, which results in an increased production cost.

Also, in the method in which the peelable sheet is bonded and the resin film and the peelable sheet are cut out, the size and forming position of the metal exposed portion need to be determined at the step of bonding the metal foil and the resin film.

### Means for Solving the Problems

In view of the aforementioned technical background, the present invention aims to provide a laminate material capable of easily forming a metal exposed portion.

That is, the present invention has the structure as recited in the following items [1] to [7].

[1] A laminate material in which a resin layer is bonded and laminated on at least one surface of a metal foil, wherein

a recess in which a foil thickness of the metal foil is decreased is formed on a part of a bonding surface of the metal foil, and

a peeled portion in which the resin layer corresponding to the recess has been peeled from the metal foil is formed.

[2] The laminate material as recited in the aforementioned Item [1], wherein minute unevenness is formed on a bottom of the recess which is different in color from a portion other than the recess.

[3] The laminate material as recited in the aforementioned Items [1] or [2], wherein the resin layer corresponding to the peeled portion is removed and the metal foil is exposed.

[4] The laminate material as recited in the aforementioned Item [1] or [2], wherein the laminate material is a double-sided laminate material in which a heat resistant resin layer is laminated on one surface of the metal foil and a heat fusible resin layer is laminated on the other surface of the metal foil, and a first peeled portion is formed on a heat fusible resin layer side surface of the metal foil and a second peeled portion is formed on a heat fusible resin layer side surface or the heat resistant resin layer side surface of the metal foil.

[5] The laminate material as recited in the aforementioned Item [4], wherein the heat fusible resin layer corresponding to the first peeled portion, and the heat fusible resin layer or the heat resistant resin layer corresponding to the second peeled portion are removed and the metal foil is exposed.

[6] A packaging body for a power storage device in which two laminate materials as recited in the aforementioned item [4] are put together in a manner in which the heat fusible resin layers face inward, and a battery element chamber for accommodating a battery element is formed by heat sealing edge portions of the laminate materials,

wherein the metal exposed portion in which the resin layer corresponding to the first peeled portion is removed faces an inside of the battery element chamber, and

the metal exposed portion in which the resin layer corresponding to the second peeled portion is removed is arranged at an outer surface of the packaging body.

[7] A power storage device in which battery elements composed of a positive electrode element, a negative electrode element, a separator, and an electrolyte are sealed in the battery element chamber of the packaging body for a power storage device as recited in the aforementioned item [5].

### Effects of the Invention

According to the laminate material as recited in the aforementioned Item [1], since the resin layer and the metal foil at the peeled portion are detached from each other by the recess of the metal foil surface, a metal exposed portion can be easily formed by removing the resin layer corresponding to the peeled portion. Further, since the metal foil of the peeled portion is covered with the resin layer, damage and contamination can be prevented.

According to the laminate material as recited in the aforementioned Item [2], since the peeled portion and the non-peeled portion can be discriminated by the naked eye due to the difference in color, it is easy to determine the cutting position of the resin film for providing the metal exposed portion.

In the laminate material as recited in the aforementioned Item [ 3], the metal exposed portion is formed at the position of the peeled portion.

According to the laminate material as recited in the aforementioned Item [4], the above-described effects can be obtained for the first peeled portion and the second peeled portion by using as a packaging body material of a power storage device.

According to the laminate material as recited in the aforementioned Item [ 5], when it used as a packaging body material of a power storage device, the first peeled portion can be used as an inner conductive portion of the packaging body, and the second peeled portion can be used as the outer conductive portion.

According to the packaging body for a power storage device as recited in the aforementioned Item [6], a battery element chamber is formed by two laminate materials, the first peeled portion of each laminate member can be used as an inner conductive portion facing the inner side of the battery element chamber, and the second peeled portion can be used as an outer conductive portion of the outer surface of the packaging body.

According to the power storage device as recited in the aforementioned Item [7], it is possible to connect the metal foils of the two laminate materials constituting the packaging body to the positive electrode and the negative electrode of the battery element, respectively. It is also possible to use the first peeled portion of one of the laminate materials as an inner conductive portion for a positive electrode facing the inside of the battery element chamber and the second peeled portion of the one of the laminate materials as an outer conductive portion for a positive electrode. It is also possible to use the first peeled portion of the other laminate material as an inner conductive portion for a negative electrode facing the inside of the battery element chamber and the second peeled portion of the other laminate material as the outer conductive portion for a negative electrode on the outer surface of the packaging body. The power storage device is a device which can exchange electricity between the battery element and the outside through the metal foils of the laminate materials and does not use tab leads.

### BRIEF DESCRIPTION OF THE DRAWINGS

FIG. 1 shows a peeling step and a cross-sectional view of a laminate material according to the present invention produced by the peeling step.

FIG. 2 shows a cutting-off step and a cross-sectional view of a laminate material according to the present invention produced by the cutting-off step.

FIG. 3 is an enlarged view of a peeled portion.

FIG. 4 is a perspective view of a packaging body of a power storage device.

FIG. 5 is a cross-sectional view of a power storage device using the packaging body shown in FIG. 4.

FIG. 6 is a cross-sectional view of a thin-type power storage device.

FIG. 7 is an appearance photograph of a laminate material after performing the peeling step according to Example 1.

FIG. 8 is a cross-sectional SEM image of the laminate material shown in FIG. 7.

FIG. 9 is an appearance photograph of a laminate material after performing the peeling step according to Example 2.

FIG. 10 is a cross-sectional SEM image of the laminate material shown in FIG. 9.

FIG. 11 is a partially enlarged view of FIG. 10.

### EMBODIMENTS FOR CARRYING OUT THE INVENTION

[Laminate Material]

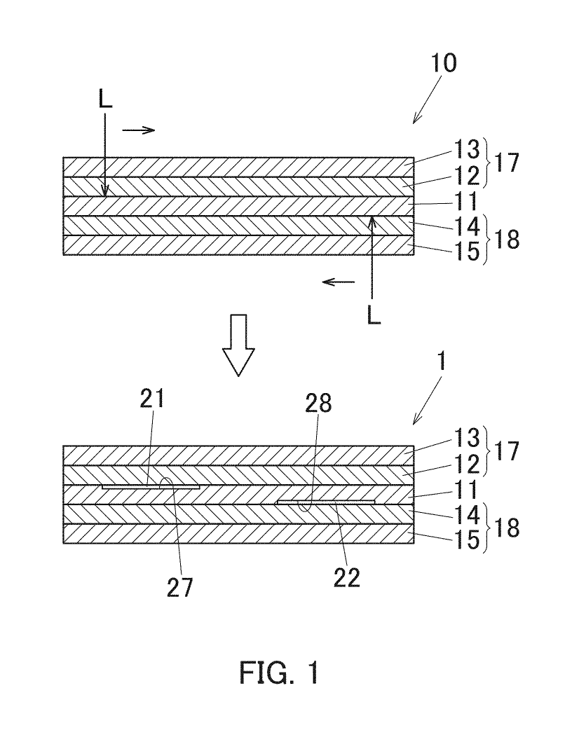

The laminate material 1 shown in FIG. 1 is used as a material of a packaging body for a power storage device, and is a double-sided laminate material in which resin layers 17 and 18 are laminated on both surfaces of a metal foil 11. The laminate material 1 is produced from a laminate raw material 10 by a method which will be described later.

In the laminate material 1, a heat resistant resin layer 13 is bonded and laminated on one surface of a metal foil 11 by an adhesive layer 12, and a heat fusible resin layer 15 is bonded and laminated on the other surface of the metal foil 11 by an adhesive layer 14. The resin layer 17 on one surface of the metal foil is two layers of an adhesive layer 12 and a heat resistant resin layer 13, and the resin layer 18 on the other surface of the metal foil 11 is two layers of an adhesive layer 14 and a heat fusible resin layer 15.

In the laminate material 1, a peeled portion 21 in which the metal foil 11 and the resin layer 17 are peeled off is formed at a part of the bonded surface of the metal foil 11 and one of the resin layers 17, and a peeled portion 22 in which the metal foil 11 and the resin layer 18 are peeled off is formed at a part of the bonded surface of the metal foil 11 and the other resin layer 18. In the peeled portion 21, 22, a recess 27, 28 in which the foil thickness is reduced is formed on the surface of the metal foil 11, and the resin layer 17, 18 corresponding to the recess 27, 28 is peeled off from the metal foil 11.

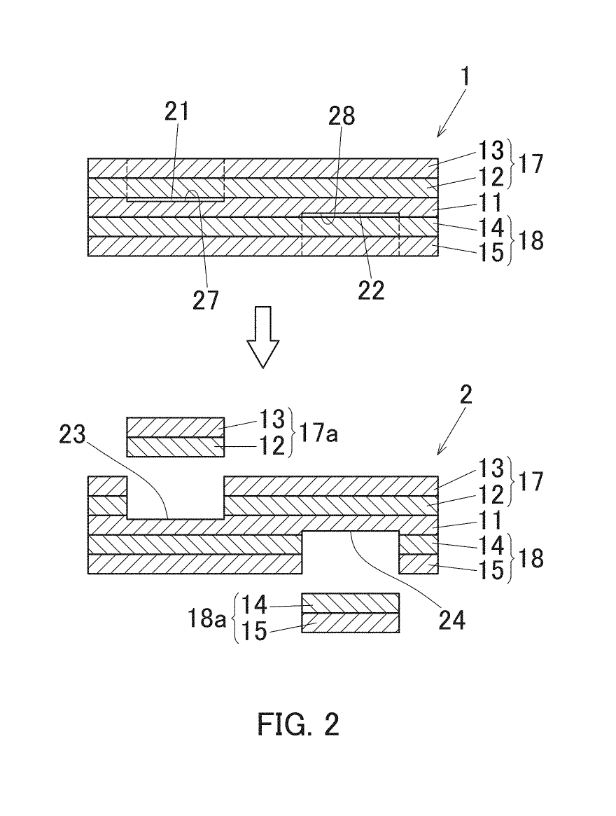

The laminate material 2 shown in FIG. 2 is a laminate material having metal exposed portions 23 and 24 in which the resin layers 17a and 18a corresponding to the peeled portions 21 and 22 of the laminate material 1 are cut off.

The laminate material according to the present invention is used as a material for various containers, such as, e.g., a packaging body of a power storage device, and used in a state in which a metal exposed portion is formed by cutting out the resin layer in a final product. However, there is a case where processing is applied to the laminate material 1 with resin layers before cutting out the resin layers. Therefore, the laminate material according to the present invention includes both the laminate material 1 with the resin layers 17a and 18a and the laminate material 2 in which metal exposed portions 23 and 24 are formed by removing the resin layers 17a and 18a.

### [Production Method of Laminate Material]

The laminate material according to the present invention is produced by performing two steps, i.e., a peeling step of irradiating a laser beam to the laminate raw material to peel the irradiated portion of the metal foil and the resin layer to thereby form a peeled portion and a cutting-off step of cutting off the resin layer corresponding to the peeled portion to expose the metal foil to thereby form the metal exposed portion. By subjecting a laminate raw material to the peeling step, the laminate material 1 shown in FIG. 1 is produced. By subjecting the laminate material 1 to the cutting-off step, the laminate material shown in FIG. 2 is produced.

Hereinafter, a laminate raw material, a peeling step, and a cutting-off step will be described in detail by exemplifying the laminate materials 1 and 2 shown in FIG. 1 and FIG. 2.

### (Laminate Raw Material)

In a laminate raw material, a resin layer is bonded and laminated on at least one surface of a metal foil. The laminate raw material 10 shown in FIG. 1 is a double-sided laminate material in which resin layers 17 and 18 are laminated on both surfaces of a metal foil 11.

In the laminate raw material 10, a heat resistant resin layer 13 is bonded and laminated on one surface of a metal foil 11 by an adhesive layer 12, and a heat fusible resin layer 15 is bonded and laminated on the other surface of the metal foil 11 by an adhesive layer 14. The resin layer 17 on one surface of the metal foil is composed of two layers, i.e., the adhesive layer 12 and the heat resistant resin layer 13, and the resin layer 18 on the other surface of the metal foil is composed of two layers, i.e., the adhesive layer 14 and the heat fusible resin layer 15.

The method of producing the laminate raw material 10 is not limited. The following is an example of a method of producing the laminate raw material.

An adhesive agent is applied to an entire area of at least one of the mating surfaces of the metal foil 11 and the heat resistant resin layer 13 to form an adhesive layer 12, and the metal foil 11 and the heat resistant resin layer 13 are bonded to each other. Similarly, the metal foil 11 and the heat fusible resin layer 15 are bonded by the adhesive layer 14. The bonding method is not limited, and a well-known method, such as, e.g., a dry lamination method, is appropriately used. Further, the order of bonding the heat resistant resin layer 13 and the heat fusible resin layer 15 is arbitrary.

Further, in cases where the heat resistant resin layer 13 itself has adhesiveness and therefore a predetermined adhesive force can be obtained, the heat resistant resin layer 13 can be directly bond to the metal foil 11 without intervening the adhesive layer 12. In the same manner, the heat fusible resin layer 15 and the metal foil 11 may be directly bonded to each other. It is not limited that the heat resistant resin layer 13 and the heat fusible resin layer 15 are each composed of a single layer. A laminate raw material in which the heat resistant resin layer 13 and the heat fusible resin layer 15 are each composed of multiple layers including two or more layers may be used.

### (Peeling Step)

As shown in FIG. 1, in the peeling step, a laser beam L is irradiated to the laminate raw material 10 to peel off the resin layer 17, 18 from the metal foil 11 without cauterizing the resin layer 17, 18 to thereby form a peeled portion 21, 22.

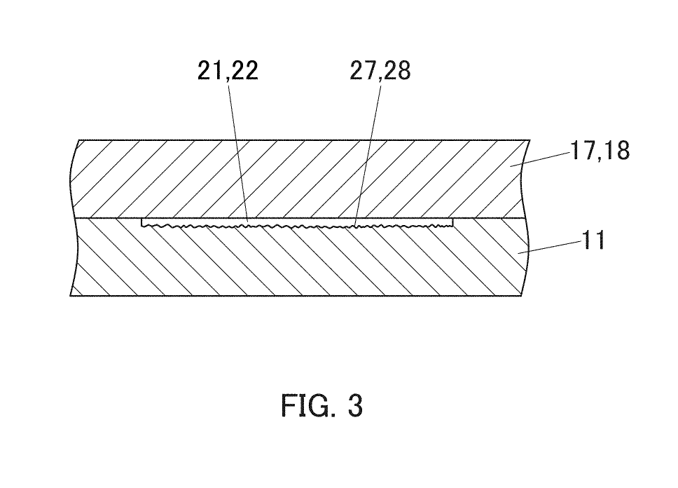

In this step, a laser having a wavelength with less absorption to the resin layer 17, 18 is used at an output level that affects the surface layer of the metal foil 11. When the laser beam of such conditions is irradiated to the laminate raw material 10, it passes through the resin layer 17, 18 without interfering therewith and reaches the surface of the metal foil 11. The metal atoms constituting the metal foil 11 are metal bonded to adjacent metal atoms. When the laser beam L is irradiated, energy is absorbed by metal atoms of the surface of the metal foil 11, and the energy absorbed by the metal atoms unbinds the metal bonds with the adjacent metal atoms. The unbound metal atoms are trapped in the resin layer 17, 18. By moving the irradiation portion of the laser beam L, the bonding of the metal atoms existing on the surface of the metal foil 11 at the irradiated position is successively unbound, the unbound metal atoms are trapped by the resin layer 17, 18 to form a metal layer different from the metal foil 11 in contact with the resin layer 17, 18, and a peeled portion 21, 22 is formed on the metal foil 11. In the peeled portion 21, 22, the metal foil 11 loses metal atoms of the surface, so that a slight recess 27, 28 is formed on the surface, and metal atoms are added to the resin layer 17, 18. Since the aforementioned action by irradiation of the laser beam is local and the heat generated at the time of unbinding metal atoms is promptly dissipated to the metal foil 11, the peeled portion 21, 22 is formed without cauterizing the resin layer 17, 18. Further, as shown in FIG. 3, the recess 27, 28 is formed by repeating the desorption of metal atoms and the dissipation of heat in a short time in accordance with the movement of the laser beam L. On the bottom of the recess 27, 28 formed by the formation of the peeled portion 21, 22, i.e., on the newly formed surface of the metal foil 11, fine unevenness is formed. As the mechanism of desorption of metal atoms, sublimation of metal atoms or separation by local melting of the surface of the metal foil may be considered.

In accordance with the formation of the peeled portion 21, 22, the recess 27, 28 is formed on the surface of the metal foil 11, which, however, merely causes the loss of metal atoms on the surface. The barrier properties of the metal foil 11 are not impaired. It is preferable that the depth of the recess 27, 28 be 0.05 μm to 5 μm in the deepest portion, particularly preferably 0.1 μm to 3 μm.

When the recess 27, 28 due to fine unevenness is formed, the metallic luster of the metal foil 11 is reduced. The color difference between the peeled portion 21, 22 and the non-peeled portion, that is, the laser irradiated portion and the laser non-irradiated portion, can be discriminated by the naked eye even when observed through the resin layer 17, 18.

As the laser having the above-mentioned function, it is recommended to use any one of an excimer laser, a YAG laser, and a YVO4 laser, having a wavelength of 150 nm to 550 nm and an output of 3 W or more.

The laser beam having a wavelength of 150 to 550 nm has less interference with the resin layer 17, 18, and therefore such a laser beam is suitable for this step of forming the peeled portion 21, 22 without affecting the resin layer 17, 18. As the excimer laser, an F2 laser having a wavelength of 157 nm, an ArF laser having a wavelength of 193 nm, an XeCl laser having a wavelength of 222 nm, and an XeF laser having a wavelength of 248 nm can be exemplified. As the YAG laser, a fourth harmonic wave having a wavelength of 260 nm or the vicinity thereof, a third harmonic wave having a wavelength of 350 nm or the vicinity thereof, and a second harmonic wave having a wavelength of 530 nm or the vicinity thereof can be exemplified. Further, as the YVO4 laser, a fourth harmonic wave having a wavelength of 260 nm or the vicinity thereof, a third harmonic wave having a wavelength of 350 nm or the vicinity thereof, and a second harmonic wave having a wavelength of 530 nm or the vicinity thereof can be exemplified. Among the above-mentioned lasers, a laser having a wavelength of particularly 530 nm or the vicinity thereof, which is a green wavelength range, is called a green laser.

Note that the metal constituting the metal foil 11 differs in wavelength having a high absorption rate. Therefore, in this step, it is preferable to use a laser having a wavelength high in absorption rate. Further, since the laser beam acts on the surface of the metal foil 11, for a plating foil, a laser having a wavelength suitable for the plating metal is selected. However, the wavelength that interferes with the resin layer 17, 18 is not preferable, and therefore the wavelength which exhibits the maximum absorption rate for the metal is not always the best wavelength. Aluminum exhibits a high absorption rate at 900 nm or the vicinity thereof, but light in the near-infrared region receives interference of the resin layer 17, 18, so a laser in the green region of 500 to 550 nm is suitable. In the case of copper, nickel, and gold, they exhibit a high absorption rate at 500 nm or the vicinity thereof, so laser in the green region of 500 to 550 nm is suitable. In the case of Fe, it exhibits a high absorption rate at 1,000 nm or the vicinity thereof, but the light in the near-infrared region receives interference with the resin layer 17, 18, so a laser in the green region of 500 to 550 nm is suitable. Further, in the case of silver, it exhibits a high absorption rate at 300 nm or the vicinity thereof, so a laser in the ultraviolet region is suitable. As described above, a laser in the green region having a wavelength of 500 to 550 nm is suitable for many metals and can be recommended in that the workability to metal is good.

The output of a laser is appropriately set according to the resin type and thickness of the resin layer 17, 18, but an output of 3 W or more is preferable for desorption of metal atoms. When it is less than 3 W, the peeling capability may be insufficient. A particularly preferable output of a laser is 3 W to 100 W.

### (Cutting-Off Step)

As shown in FIG. 2, the resin layer 17, 18 is cut along the contour of the peeled portion 21, 22 of the laminate material 1 with resin layers to cut out the resin layer 17a, 18a corresponding to the peeled portion 21, 22. As described above, the peeled portion 21, 22 and the non-peeled portion can be discriminated with the naked eye due to the difference in color between the laser irradiated portion and the laser non-irradiated portion, so that the cutting position can be easily determined. The metal foil 11 is exposed by cutting out the resin layer 17a, 18a, so that the metal exposed portion 23, 24 is formed. Thus, a laminate material 2 with metal exposed portions is produced.

Cutting of the resin layer 17a, 18a is carried out by using a physical blade, such as, e.g., a Thomson sword and a rotary die, or a laser blade by a laser, such as, e.g., a CO₂ laser, having a high absorption rate for a resin.

The laminate raw material 10 used in the above-described method is a material obtained by laminating the resin layer 17, 18 on the entire surface of the metal foil 11. The shape, size, and forming position of the peeled portion 21, 22, i.e., the metal exposed portion 23, 24, can be arbitrarily set at the time of carrying out the peeling step. A plurality of types of laminate materials 1 and 2 different in shape, size, number, and forming position of the peeled portion 21, 22 (metal exposed portion 23, 24) can be produced from one type of a laminate raw material 10. By commonalizing the laminate raw material 10 which is a starting material, it is possible to eliminate waste of material and improve the production efficiency.

In the laminate raw material, a resin layer is laminated on at least one surface of the metal foil, and the laminate material according to the present invention is required that the peeled portion or the metal exposed portion is formed on the resin layer side surface of the metal foil. The mode of the other surface of the metal foil is any one of modes (1) to (3) described below, and in any case, the method according to the present invention can be applied.

(1) a resin layer is laminated

(2) a layer other than a resin layer is formed

(3) nothing is laminated

The laminate raw material 10 shown as an example corresponds to the above-described mode (1). In some cases, however, a peeled portion or a metal exposed portion is formed only on one surface of the laminate raw material 10 by executing a peeling step or a cutting-off step with respect to the laminate raw material 10 in which resin layers 17 and 18 are laminated on both surfaces of the metal foil 11. The lamination mode of the laminate raw material and the surface to be processed differ depending on the application of the laminate material 1, 2.

It is not limited that the cutting-off step is performed subsequent to the peeling step. Another step may be performed between the two steps. In cases where the above-described laminate material 1 is used as a packaging material, a flat sheet is shaped into a case having a configuration capable of accommodating an item to be packaged, and then the item to be packaged is placed in the case. Thereafter, the heat fusible resin layers are heat sealed at its opening to thereby encapsulate the item to be packaged. The processing into a case capable of accommodating the item to be packaged is exemplified by processing in which a flat sheet is plastically deformed into a three-dimensional shape by pressing, such as, e.g., bulging and drawing, and a bag-making processing in which a flat sheet is shaped into a bag shape. The peeling step and the cutting-off step can be performed at any time from a state of being a flat sheet to a state after performing the heat sealing as long as processing can be performed. Therefore, the laminate material 1, 2 according to the present invention is not limited to a flat sheet, but may be a three-dimensional shape in some cases.

In the main body 40 of the packaging body 30 of the power storage device 100 which will be described later, a flat sheet is pressed to form the recess 41. The pressing may be performed at any time, before the peeling step, between the peeling step and the cutting-off step, or after the cutting-off step. For example, the formation of a plurality of peeled portions 21 and 22 can be performed by selecting the order of: performing the peeling step on the flat sheet laminate raw material 10 to enhance the work efficiency; performing the press working on the laminate material 1 with resin layers to protect the metal foil 11 of the peeled portions 21 and 22 with the resin layers 17 and 18; and thereafter performing the cutting-off step. Although the metal exposed portion 24 facing the battery element chamber 60 must be formed by performing a cutting-off step before heat sealing, the metal exposed portion 23 on the outer surface of the packaging body 30 may be formed by performing a cutting-off step even after the heat sealing.

When the peeled portions 21 and 22 are formed by the above-described method to prepare the laminate 1, although the shape and size of the metal exposed portions 23 and 24 of the laminate material 2 which is a final product and the positions of the metal exposed portions 23 and 24 are also determined, the metal foil 11 at the peeled portions 21 and 22 is covered and protected by the resin layers 17 and 18. By leaving the resin layers 17 and 18 until the metal exposed portions 23 and 24 are needed, it is possible to prevent damage and contamination due to contact between laminate materials 1, adhesion of chemicals, contact of a tool, etc., at the time of the press working as described above.

### [Power Storage Device and its Packaging Body]

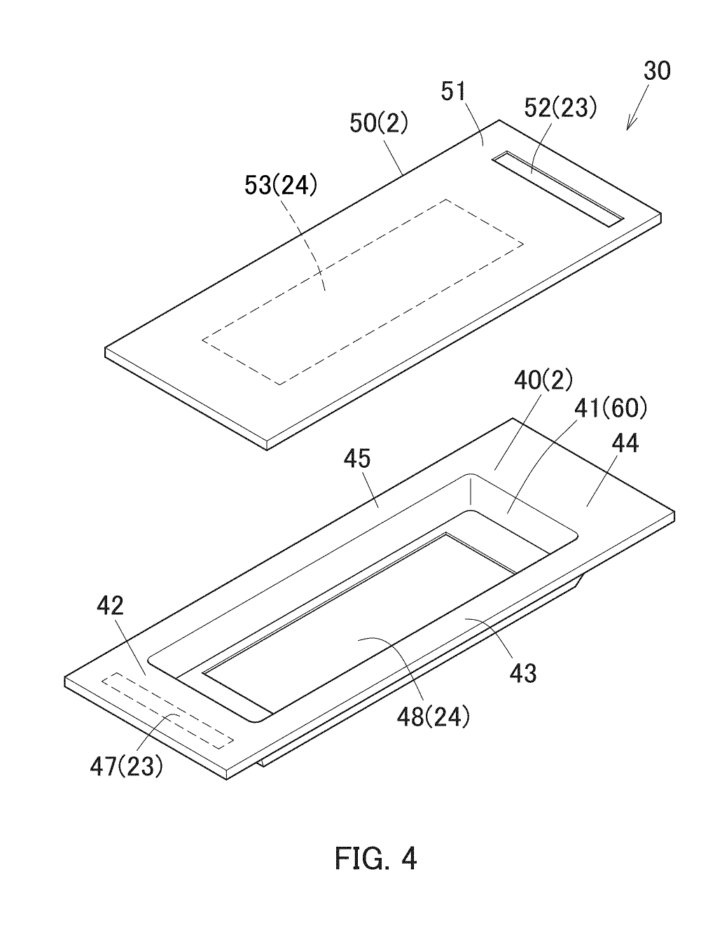

FIG. 4 to FIG. 6 show packaging bodies 30 and 35 for power storage devices made of the laminate material produced by the above-described method and power storage devices 100 and 101 using these packaging bodies 30 and 35. The power storage devices 100 and 101 are no tab lead devices that exchange electricity through the metal foil 11 of the laminate material.

### (First Packaging Body and Power Storage Device)

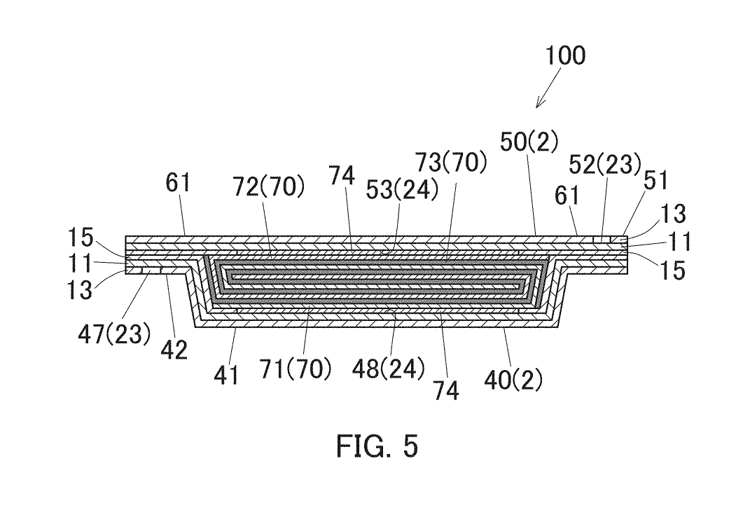

FIG. 4 shows a packaging body 30 for a power storage device composed of laminate materials 2 (see FIG. 2) each having metal exposed portions 23 and 24 on both surfaces, and FIG. 5 shows a power storage device 100 using the packaging body 30. Note that in FIG. 5, the illustration of the adhesive layers 12 and 14 of the laminate material 2 is omitted and only the metal foil 11, the heat resistant resin layer 13, and the heat fusible resin layer 15 are illustrated.

The main body 30 is composed of a main body 40 having a rectangular recess 41 in a plan view and a lid 50 of a flat sheet, and the main body 40 and the lid 50 are each configured by a laminate raw material 2 in which metal exposed portions 23 and 24 are formed by performing the peeling step and the cutting-off step on required portions of the laminate raw material 10 shown in FIG. 1. In the packaging body 30, the space closed by covering the recess 41 of the main body 40 with the lid 50 served as the battery element chamber 60.

The main body 40 has a recess 41 in which the heat fusible resin layer 15 side surface is recessed formed by subjecting a laminate material of a flat sheet to processing, such as, e.g., bulging and drawing and flanges 42, 43, 44, and 45 which extend substantially horizontally outward from the opening edge of the recess 41. The metal exposed portion 24 formed on the inner side of the bottom wall of the recess 41, i.e., the heat fusible resin layer 15 side surface, serves as a first inner conductive portion 48. The metal exposed portion 23 formed on the heat resistant resin layer 13 side surface of one of the short side flanges 42 serves as a first outer conductive portion 47.

The lid 50 has the same size as a size of the planar size of the main body 40. The metal exposed portion 24 formed at a position facing the first inner conductive portion 48 of the main body 40 on the heat fusible resin layer 15 side surface of the lid 50 facing the main body 40 serves as a second inner conductive portion 53. Further, the metal exposed portion 23 formed on the heat resistant resin layer 13 side surface of one of the short side edge portion 51 of the lid 50 serves as a second outer conductive portion 52.

When the main body 40 and the lid 50 are assembled, the first inner conductive portion 48 and the second inner conductive portion 53 face the inside of the battery element chamber 60, and the first outer conductive portion 47 and the second outer conductive portion 52 are exposed to the outer surface of the packaging body 30.

The battery element 70 is a laminate obtained by placing a separator 73 between a positive electrode 71 in which a positive electrode active material is coated on a metal foil and a negative electrode 72 in which a negative electrode active material is coated on a metal foil. Note that the positive electrode 71 is a positive electrode element according to the present invention, and in the same manner, the negative electrode 72 is a negative electrode element.

The power storage device 100 is produced by connecting the end portion of the positive electrode 71 of the battery element 70 to the first inner conductive portion 48 of the main body 40 via the conductive binder 74, connecting the end portion of the negative electrode 72 to the second inner conductive portion 53 of the lid 50 via the conductive binder 74, and heat sealing the periphery of the battery element chamber 60 with an electrolyte injected to form the heat-sealed portion 61.

In the power storage device 100, the positive electrode foil 71 is configured to conduct to the metal foil 11 of the main body 40 at the first inner conductive portion 48 in the battery element chamber 60, and the first outer conductive portion 47 is configured to conduct to the outside on the outer surface of the packaging body 30. In the same manner, the negative electrode foil 72 is configured to conduct to the metal foil 11 of the lid 50 at the second inner conductive portion 53 in the battery element chamber 60, and the second outer conductive portion 52 is configured to conduct to the outside on the outer surface of the packaging body 30. The power storage device 100 exchanges electricity through the first outer conductive portion 47 and the second outer conductive portion 52 provided on the outer surface of the packaging body 30.

### (Second Packaging Body and Power Storage Device)

In the packaging body of the power storage device, the outer conductive portion for exchanging electricity with the outside is not limited to be provided on the heat resistant resin layer 13 side surface of the laminate material, but it may be provided on the heat fusible resin layer 15 side surface. Further, the battery element is not limited to a laminate composed of a metal foil for a positive electrode and a metal foil for a negative electrode.

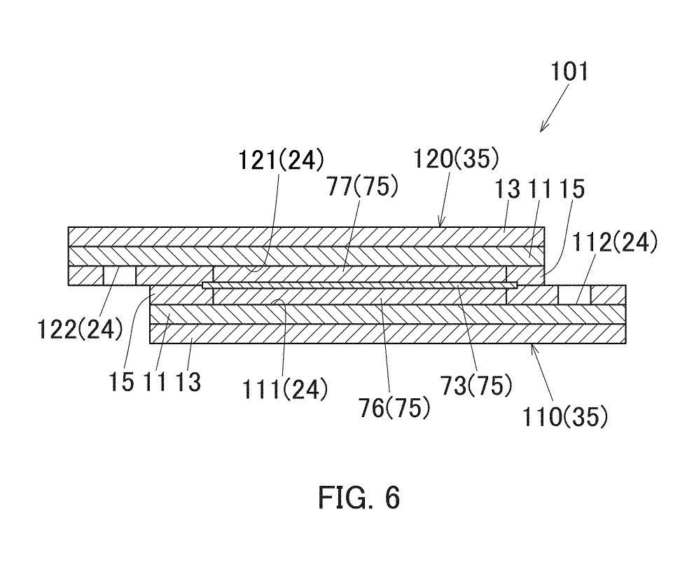

The power storage device 101 shown in FIG. 6 is a thin type device in which the packaging body 35 is composed of two flat laminate materials and a metal foil of a laminate material is used as a positive electrode or a negative electrode.

In the first laminate material 110 using the metal foil 11 as a positive electrode, two metal exposed portions 24 are formed on the heat fusible resin layer 15 side surface, and serve as the first inner conductive portion 111 and the first outer conductive portion 112. In the second laminate material 120 using the metal foil 11 as a negative electrode, two metal exposed portions 24 are formed on the heat fusible resin layer 15 side surface, and serve as the second inner conductive portion 121 and the second outer conductive portion 122.

The power storage device 101 is produced as follows. A positive electrode active material layer 76 is applied to the first inner conductive portion 111 of the first laminate material 110. A negative electrode active material layer 77 is applied to the second inner conductive portion 121 of the second laminate material 120. A separator 73 is sandwiched between two laminate materials 110 and 120, and the two laminate materials 110 and 120 are overlapped so that the end portions thereof are shifted to expose the first outer conductive portion 112 and the second outer conductive portion 122. In this overlapped state, the periphery of the first inner conductive portion 111 and that of the second inner conductive portion 121 are heat sealed. Note that the positive electrode active material layer 76 and the negative electrode active material layer 77 correspond to the positive electrode element and the negative electrode element in the present invention, respectively. Also note that the positive electrode active material layer 76, the negative electrode active material layer 77, the separator 73, and the electrolyte are the battery element 75, and the space where the battery element 75 exists is the battery element chamber (no reference numeral is allotted).

### [Other Applications of Laminate Material]

The application of the laminate material according to the present invention is not limited to a packaging body of a power storage device, and the packaging body is not limited to the form shown in FIG. 5 and FIG. 6. Note that the surface, position, and number of the peeled portion to be provided differ depending on the application of the laminate material. Further, in the two packaging bodies 30 and 35, it is not limited that the outer conductive portion (metal exposed portion) of the packaging body of the power storage device is provided on the heat resistant resin layer 13 side surface. Like the packaging body 35 shown in FIG. 6, when two laminate materials are overlapped so that the end portions thereof are shifted, the heat fusible resin layer 15 is exposed to the outer surface of the packaging body 35. For this reason, an outer conductive portion can be provided on the heat fusible resin layer 15 side surface. In the two laminate materials constituting the packaging body, one of the laminate materials can be used so that the metal exposed portion formed on the heat fusible resin layer 15 side surface is used as an outer conductive portion, and the other laminate material can be used so that the metal exposed portion formed on the heat resistant resin layer 13 side surface is used as an outer conductive portion. On the other hand, the inner conductive portion facing the battery element chamber must be provided on the heat fusible resin layer 15 side surface. Therefore, in the laminate material used for a packaging body of a power storage device having no tab lead, it is required that metal exposed portions 23 and 24 are provided on both the heat resistant resin layer 13 side surface and the heat fusible resin layer 15 side surface, or a plurality of metal exposed portions 24 are provided on the heat fusible resin 15 side surface. That is, in a laminate material provided with a resin layer, a first peeled portion of the packaging body to be served as an inner conductive portion is formed on the heat fusible resin layer side surface, and a second peeled portion for serving as an outer conductive portion is formed on the heat fusible resin layer side surface or the heat fusible resin layer side surface. Further, in the packaging body of the power storage device provided with tab leads, no metal exposed portion is provided on the heat fusible resin layer side. However, by providing a metal exposed portion on the heat resistant resin layer side, this metal exposed portion can be used for leakage check.

The laminate material according to the present invention can also be used as a packaging material for food and liquid in addition to a packaging body of an electric storage device. The surface for forming the metal exposed portion (peeled portion), and the number and size of the metal exposed portion (peeled portion) are not limited, and can be arbitrarily set according to the application of the laminate material. As an example of the application of the packaging material of the laminate material for food and liquid, a food container can be exemplified. In a laminate material for food containers, by forming a metal exposed portion on the heat resistant resin layer side surface which is the outer surface of the container and the heat fusible resin layer side surface which is the inner face of the container, it is possible to provide a food container capable of bringing a heating member into contact with the metal exposed portions or applying heat by Joule heat via the content.

### [Constituent Material of Laminate Material]

Although the present invention does not limit the materials of the respective layers constituting the laminates 1 and 2, the following materials can be exemplified as preferable materials.

As the metal foil 11, an aluminum foil, a stainless steel foil, a nickel foil, a copper foil, a titanium foil, and a clad foil of these metals can be exemplified, and a plating foil plated on the aforementioned metal foil can also be exemplified. It is also preferable to form a chemical conversion coating on these metal foils. The thickness of the metal foil 11 is preferably 15 μm to 150 μm, more preferably 20 μm to 80 μm.

As the heat resistant resin constituting the heat resistant resin layer (outer layer) 13, a heat resistant resin which does not melt at the heat sealing temperature when heat-sealing the laminate materials is used. As the heat resistant resin, it is preferable to use a thermoplastic resin having a melting point higher than the melting point of the thermoplastic resin constituting the heat fusible resin layer 15 by 10° C. or more, and it is particularly preferable to use a thermoplastic resin having a melting point higher than the melting point of the thermoplastic resin by 20° C. or more. For example, a polyamide film, a polyester film, etc., can be exemplified, and these stretched films are preferably used. Among them, in terms of formability and strength, a biaxially stretched polyamide film or a biaxially stretched polyester film, or a multilayer film containing these films is particularly preferable. Further, it is preferable to use a multilayer film in which a biaxially stretched polyamide film and a biaxially stretched polyester film are laminated. As the polyamide film, it is not particularly limited, but for example, a polyamide 6 film, a polyamide 66 film, and a polyamide MXD film can be exemplified. Further, as the biaxially stretched polyester film, a biaxially stretched polybutylene terephthalate (PBT) film, a biaxially stretched polyethylene terephthalate (PET) film, etc., can be exemplified. In addition, the heat resistant resin layer 13 may be formed of a single layer, or may be formed of multiple layers made of, for example, a PET film/a polyamide film. Further, the thickness is preferably within the range of 9 μm to 50 μm.

As the thermoplastic resin constituting the heat fusible resin layer 15, in terms of chemical resistance and heat sealability, the thermoplastic resin is preferably composed of polyethylene, polypropylene, an olefin based copolymer, an acid modified product thereof, and an ionomer thereof. As the olefin based copolymer, an EVA (ethylene-vinyl acetate copolymer), an EAA (ethylene-acrylic acid copolymer), and an EMAA (ethylene-methacrylic acid copolymer) can be exemplified. Further, a polyamide film (for example, polyamide 12) or a polyimide film can also be used. Further, the thickness is preferably within the range of 20 μm to 80 μm.

As the adhesive agent 12 on the heat resistant resin layer 13 side, for example, it is preferable to use an adhesive agent containing a two-part curing type polyester-urethane based resin including a polyester resin as a main agent and a polyfunctional isocyanate compound as a curing agent, or a polyether-urethane based resin. On the other hand, as the adhesive agent 14, 24 on the first heat fusible resin layer 15 side, an adhesive agent, such as, e.g., a polyurethane based adhesive agent, an acrylic based adhesive agent, an epoxy based adhesive agent, a polyolefin based adhesive agent, an elastomer based adhesive agent, a fluorine based adhesive agent, etc., can be exemplified.

### Example 1

A peeling step and a cutting-off step were performed on both surfaces of the laminate raw material 10 having the laminate structure shown in FIG. 1 to form metal exposed portions 23 and 24.

Each layer of the used laminate raw material 10 was as follows. The laminate raw material 10 was prepared by bonded resin films on both surfaces of the metal foil 11 by a dry lamination method.

Metal foil 11: 40 μm thick aluminum foil (JIS H4160, A8079H) Heat resistant resin layer 13: 25 μm thick biaxially stretched polyamide film

Adhesive layer 12: two-part curing type polyester-urethane based adhesive agent, coating amount of 4 g/m³

Heat fusible resin layer 15: 40 μm thick unstretched polypropylene film

Adhesive layer 14: two-part curing type acid-modified polypropylene based adhesive agent, coating amount of 3 g/m³

### [1] Example 1: Heat Fusible Resin Layer 15 Side Surface (Peeling Step)

Using a YVO4 laser having a wavelength of 523 nm, an output of 15 W, and a spot diameter of 2.2 mm, a laser beam was irradiated while scanning at a scanning speed of 400 m/s to a region of 30 mm×40 mm on the heat fusible resin layer 15 side surface of the laminate raw material 10.

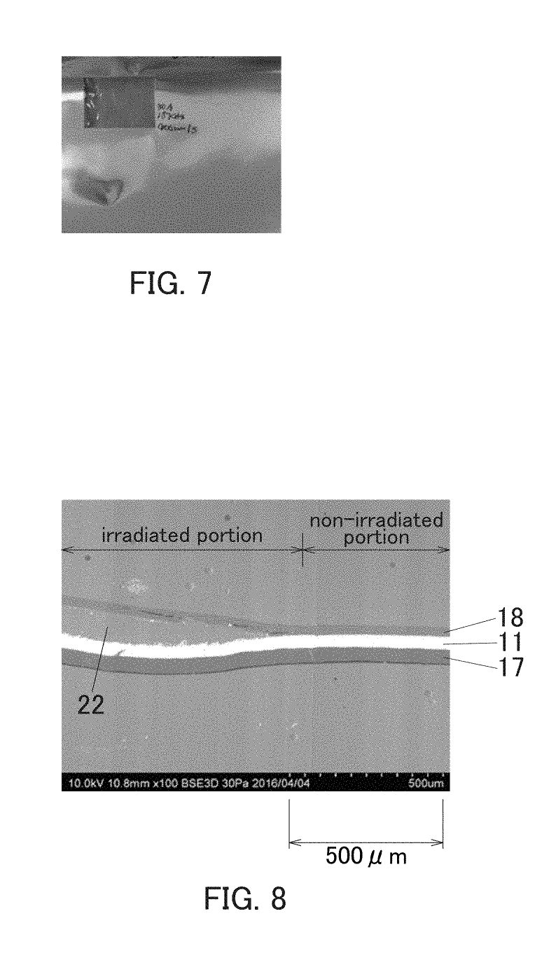

FIG. 7 shows a photograph of the appearance of the laminate material 1 after irradiation. The dark colored rectangle shape shown at the top left of this photograph indicates an irradiated portion, and the irradiated portion can be identified with the naked eye.

FIG. 8 shows a cross-sectional SEM image after irradiation. In the SEM image, the central white portion indicates the metal foil 11, the gray layer above the metal foil 11 indicates the resin layer 18 composed of the heat fusible resin layer 15 and the adhesive layer 14, and the gray layer of the metal foil 11 indicates the resin layer 17 composed of the heat resistant resin layer 13 and the adhesive layer 12. As shown in FIG. 8, it was confirmed that the metal foil 11 and the resin layer 18 were peeled from each other at the laser irradiated portion and a peeled portion 22 was formed.

The depth of the deepest portion of the recess 28 of the metal foil 11 at the peeled portion 22 was analyzed from the cross-sectional SEM image and was found to be 2 μm.

### (Cutting-Off Step)

The periphery of the peeled portion 22 formed by the peeling step was cut with a laser blade and the resin layer 18a corresponding to the peeled portion 21 was cut out. The laser blade was a CO₂ laser with an output of 15 W and a spot diameter of 2.2 mm, and scanned at a scanning speed of 1,000 mm/. It was confirmed that the metal foil 11 was exposed by the cutting of the resin layer 18a and the metal exposed portion 24 was formed.

### [2] Example 2: Heat Resistant Resin Layer Side 13 Surface

Using a YAG laser having a wavelength of 355 nm, an output of 5 W, and a spot diameter of 2.2 mm, an area of 1 mm×30 mm on the heat resistant resin layer 13 side surface of the laminate raw material 10 was scanned with the laser beam at a scanning speed of 300 m/s.

FIG. 9 shows a photograph of the appearance of the laminate material 1 after irradiation. The line-shaped portion at the center upper portion of this photograph indicates an irradiated portion, and the irradiated portion can be identified with the naked eye.

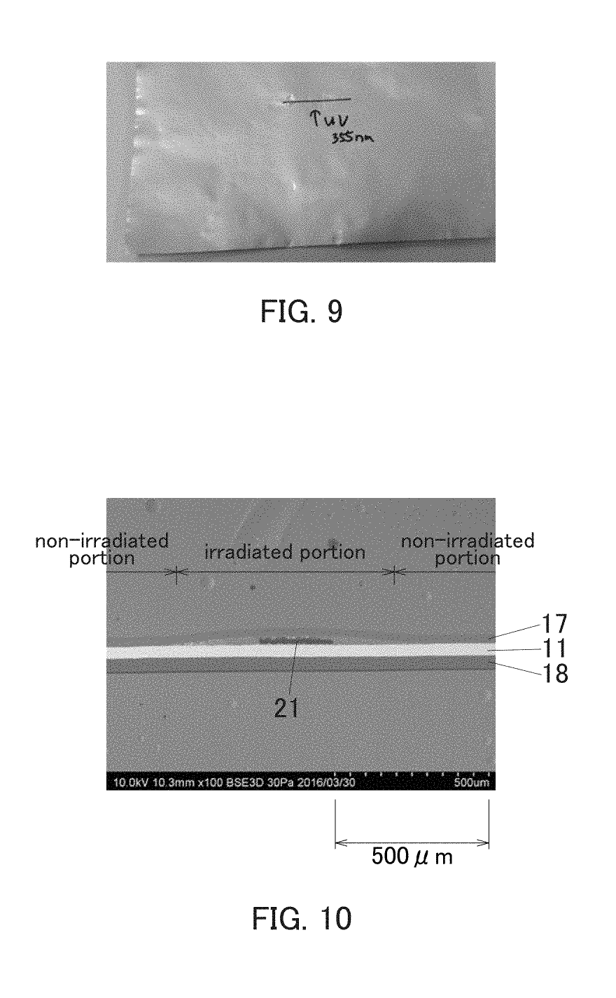

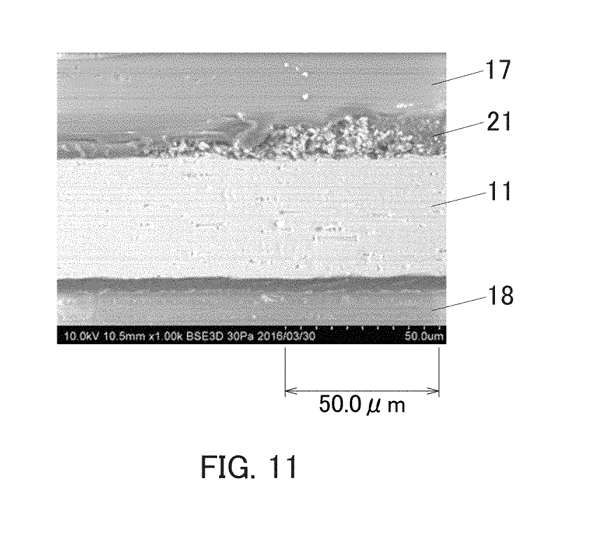

Also, FIG. 10 shows a cross-sectional SEM image after the irradiation, and FIG. 11 shows the partially enlarged image of FIG. 10. In FIG. 10 and FIG. 11, the white portion at the center indicates the metal foil 11, the gray layer above the metal foil 11 indicates the resin layer 17 composed of the heat resistant resin layer 13 and the adhesive layer 12, and the gray layer below the metal foil 11 indicates the resin layer 18 composed of the heat fusible resin layer 15 and the adhesive layer 14. As shown in FIG. 11 and FIG. 12, it was confirmed that the metal foil 11 and the resin layer 17 were peeled from each other at the laser irradiated portion and the peeled portion 21 was formed.

Further, the depth of the deepest portion of the recess 27 of the metal foil 11 at the peeled portion 21 was analyzed from the cross-sectional SEM image and the depth was 2 μm.

### (Cutting-Off Step)

The periphery of the peeled portion 21 formed by the peeling step was cut with the same method as in Example 1 to cut off the resin layer 17a corresponding to the peeled portion 21. It was confirmed that the metal foil 11 was exposed by cutting out the resin layer 17 and the metal exposed portion 23 was formed.

The present application claims priority to Japanese Patent Application No. 2016-112420 filed on Jun. 6, 2016, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope according to the present invention.

### INDUSTRIAL APPLICABILITY

The laminate material according to the present invention can be suitably used as a packaging body material in which a part of a resin layer is removed to expose a metal foil.

### DESCRIPTION OF REFERENCE SYMBOLS

1, 2: laminate material
10: laminate raw material
11: metal foil
12, 14: adhesive layer
13: heat resistant resin layer
15: heat fusible resin layer
17, 18: resin layer
21, 22: peeled portion
23, 24: metal exposed portion
27, 28: recess
30, 35: packaging body
40: main body (laminate material)
47: first outer conductive portion (metal exposed portion)
48: first inner conductive portion (metal exposed portion)
50: lid (laminate material)
52: second outer conductive portion (metal exposed portion)
53: second inner conductive portion (metal exposed portion)
60: battery element chamber
70, 75: battery element
100, 101: power storage device
110: first laminate material (laminate material)
111: first inner conductive portion (metal exposed portion)
112: first outer conductive portion (metal exposed portion)
120: second laminate material (laminate material)
121: second inner conductive portion (metal exposed portion)
122: second outer conductive portion (metal exposed portion)

1. A laminate material in which a resin layer is bonded and laminated on at least one surface of a metal foil, wherein
a recess in which a foil thickness of the metal foil is decreased is formed on a part of a bonding surface of the metal foil, and
a peeled portion in which the resin layer corresponding to the recess has been peeled from the metal foil is formed.

2. The laminate material as recited in claim 1, wherein
minute unevenness is formed on a bottom of the recess which is different in color from a portion other than the recess.

3. The laminate material as recited in claim 1, wherein
the resin layer corresponding to the peeled portion is removed and the metal foil is exposed.

4. The laminate material as recited in claim 1, wherein
the laminate material is a double-sided laminate material in which a heat resistant resin layer is laminated on one surface of the metal foil and a heat fusible resin layer is laminated on the other surface of the metal foil, and
a first peeled portion is formed on a heat fusible resin layer side surface of the metal foil and a second peeled portion is formed on a heat fusible resin layer side surface or the heat resistant resin layer side surface of the metal foil.

5. The laminate material as recited in claim 4, wherein
the heat fusible resin layer corresponding to the first peeled portion, and the heat fusible resin layer or the heat resistant resin layer corresponding to the second peeled portion are removed and the metal foil is exposed.

6. A packaging body for a power storage device in which two laminate materials as recited in claim 5 are put together in a manner in which the heat fusible resin layers face inward, and a battery element chamber for accommodating a battery element is formed by heat sealing edge portions of the laminate materials, wherein
a metal exposed portion in which the resin layer corresponding to the first peeled portion is removed faces an inside of the battery element chamber, and
a metal exposed portion in which the resin layer corresponding to the second peeled portion is removed is arranged at an outer surface of the packaging body.

7. A power storage device in which the battery element composed of a positive electrode element, a negative electrode element, a separator, and an electrolyte is sealed in the battery element chamber of the packaging body for a power storage device as recited in claim 6.
